(19) United States
(12) Patent Application Publication
(10) Pub. No.: US 2016/0288412 A1
(43) Pub. Date: Oct. 6, 2016

(54) Device for Processing Photopolymerizable Material in Order to Construct a Shaped Body Layer by Layer

(71) Applicant: TECHNISCHE UNIVERSITÄT WIEN, Wien (AT)

(72) Inventors: Jürgen STAMPFL, Wien (AT); Simon GRUBER, Wien (AT)

(21) Appl. No.: 15/038,148

(22) PCT Filed: Nov. 20, 2014
(86) PCT No.: PCT/AT2014/000207

§ 371 Date: May 20, 2016

(30) Foreign Application Priority Data
Nov. 22, 2013 (AT) A 901/2013

(51) Int. Cl. B29C 67/00; B33Y 30/00; B33Y 50/02; B33Y 10/00

(52) U.S. Cl. CPC B29C 67/007; B29C 67/0088; B33Y 10/00; B33Y 30/00; B33Y 50/02; B29C 67/0085; B29C 67/0092; B29K 2105/16

(57) ABSTRACT

The method for processing photopolymerizable material for the layered construction of a shaped body comprises
a) providing a tank having a bottom transparent at least in some region, in which the photopolymerizable material is contained;
b) moving a construction platform to such a height that a layer of the photopolymerizable material with a specified thickness is defined between the lower side of the construction platform or, if already present, the lowermost cured layer of the part of the shaped body formed thereon and the tank bottom;
c) exposing the layer from below through the tank bottom by position-specific exposure so as to cure the material layer in the desired shape;
d) repeating steps b) and c) until the last layer of the shaped body is formed.

The photopolymerizable material has a viscosity of at least 20 Pa·s at room temperature (20° C.), and the layer of the photopolymerizable material is heated in the tank to a temperature of at least 30° C. so as to lower its viscosity.

The invention relates to a method for processing photo-polymerizable material for the layered construction of a shaped body, comprising
a) providing a tank having a bottom transparent at least in some region, in which the photopolymerizable material is contained;
b) moving a construction platform to such a height that a layer of the photopolymerizable material with a specified thickness is defined between the lower side of the construction platform or, if already present, the lowermost cured layer of the part of the shaped body formed thereon and the tank bottom;
c) exposing the layer from below through the tank bottom by position-selective exposure so as to cure the material layer in the desired shape;
d) repeating steps b) and c) until the last layer of the shaped body is formed.

The invention further relates to a device for carrying out said method.

A method and a device of the initially defined kind are known from EP 2505341 A1 and WO 2010/045950 A1.

Such methods and devices allow for the generative manufacture of shaped parts based on lithography, in particular in the context of what is called rapid prototyping. In said stereolithographic methods, a newly applied material layer is each polymerized in the desired shape by position-selective exposure, whereby, by layered shaping, the desired body is successively produced in its three-dimensional shape resulting from the succession of the applied layers.

Unlike competing 3D printing methods, lithography-based generative manufacturing offers the great advantage of achieving a very good precision and surface quality of the printed components. The great disadvantage, which prevents these methods from being widely used in manufacturing engineering, is the low fracture toughness (impact strength) of these materials. Competing methods (e.g. selective laser sintering—SLS, or fused deposition modeling—FDM) allow for the processing of thermoplastic materials (e.g. ABS—acrylonitrile butadiene styrene), which have substantially higher impact strengths than photopolymers. That is why presently available generative manufacturing methods can only be used for selected applications, e.g. prototyping. The use as manufacturing tools for the series production of plastic parts only makes sense in exceptional cases, yet represents by far the biggest market.

The low impact strength of photopolymers is, above all, linked with the weak intermolecular interaction between the chains of the polymer network. The basis for applications based on photopolymerization (paints and coatings industry, dental composite fills) usually are relatively thin starting substances, which are readily workable at room temperature because of their low viscosity. During photopolymerization, covalent bonds are formed by chemical cross-linking, and the resulting polymer network has a relatively high hardness and stiffness due to the strong binding energies of the covalend cross-linking points. The secondary bonds, which are of physical nature (Van der Waals bonds, hydrogen bridge bonds) likewise act between the polymer chains, yet contribute little to the mechanical properties of the overall network due to their low binding energies. This constellation involves the problem of a low material fracture toughness resulting therefrom: as soon as an incipient crack in the sample breaks open the covalent bonds in front of it because of the high stress concentrations at the tip of the crack, the crack starts to grow. The polymer network in this form has no chance of plastic deformation, and the toughness is substantially only determined by the surface energy of the newly created surface on the tip of the crack.

It is known that thermoplastics can be modified in terms of toughness by selectively introducing small elastomer particles, which will cause a plurality of small cracks in a relatively large volume under mechanical stress. The elastomer particles will, however, prevent the crack from growing further, allowing the surrounding matrix to plastically deform (crazing) and dissipate energy. So, the basis of a fracture-tough polymer is a matrix that has the potential to plasticize, and embedded particles producing a plurality of subcritical cracks, thus enabling plasticizing in a large volume.

With photopolymers, plasticizing and the respective increase in toughness can be achieved by using monomer systems with strong intermolecular interactions. This will, however, result in the starting materials being either solid or extremely viscous at room temperature such that their processability in lithography-based generative manufacturing will be considerably complicated.

The processing of filled photopolymerizable materials (slip) again implies a high viscosity of the starting material. In this case, a sinterable material (e.g. ceramics or metal) is admixed in powder form to a thick, photosensitive synthetic resin. The cured polymer will act as a binder during the curing of the individual layers. When the layered construction of the shaped body is completed, the cured polymer is thermally removed and the remaining filler material (e.g. ceramic powder) will subsequently be sintered together to a solid structure. By this method, is has become possible to exploit all the advantages of generative manufacturing even for materials that would basically not be suitable for these methods. In this context, the degree of filling, i.e. the portion of powder in the slip, is one of the key factors relating to processability and material quality. In most cases, high degrees of filling are, however, linked with a high viscosity of the starting material, which raises some problems such as high reaction forces, demixing of the slip, and more difficult material supplies.

The present invention, therefore, aims to further develop lithography-based generative manufacturing methods to the effect that starting materials having highly viscous or even solid consistencies can also be processed. Furthermore, the invention aims to process high-quality materials that are suitable not only for prototyping but also for manufacturing (rapid manufacturing).

To solve this object, the invention in a method of the initially defined kind essentially provides that the photopolymerizable material comprises an elevated intermolecular interaction and the layer of the photopolymerizable material is heated in the tank to a temperature of at least 30° C. so as to lower its viscosity. The elevated intermolecular interaction manifests itself in an elevated viscosity at room temperature (20° C.). In the present case, the intermolecular interaction will, in particular, be considered to be sufficient if the starting material has a viscosity of at least 20 Pa·s at room temperature. In a preferred manner, the material layer is heated to at least 40° C. The invention is based on the finding that different radiation-curing polymers already exhibit a marked decrease of the viscosity at a small increase in the temperature. In general, heating to a maximum of 50° C. will do such that any additional power consumption will be within justifiable limits. In special cases, heating up to 80° C. may be required. At higher temperatures, an undesired thermal polymerization of the photopolymers will occur. Material heating preferably only takes place in the process zone of the plant. The process zone comprises the region between the transparent tank bottom and the shaped body constructed so far. Typically, a photopolymer layer having a thickness of between 10 μm and 1000 μm is heated. The remaining process space of the plant, in which the shaped body is contained, may have a temperature below the temperature of the process zone. The viscous material is preferably heated over a large surface area and directly at the interface (tank bottom).

It was, furthermore, found that a higher reduction of the viscosity to the effect that the material distribution and the layer formation in the tank will be successful without major force and time expenditures will preferably only be ensured if the material bath is heated as a whole rather than the material just in the exposed area. The heating of only a partial amount of the material in the region of a mixing device formed as a wire, as is described in EP 2505341 A1, turned out to be inadequate.

Due to the invention it has become possible in the context of lithography-based generative manufacturing methods to use starting materials that enable improved material properties to be achieved in the end product, in particular high precision, very good surface quality, excellent impact strength, and enhanced thermoforming resistance. Such methods can, therefore, be used in series production to an increasing extent.

A preferred process control provides that the temperature of the photopolymerizable material is maintained at a temperature of at least 30° C., preferably at least 40° C., during steps b), c), and d). The material bath is thus consistently maintained at the respectively required, elevated temperature so as to obviate the need for frequent temperature changes.

In a particularly preferred manner, heating of the photo-polymerizable material, and optionally maintaining of the temperature, are effected by the input of heat via the tank bottom, in particular by at least one heating element disposed on or in the tank bottom, e.g. heating films. The input of heat thus occurs via the tank bottom so as to ensure an energy-efficient heat transfer. The input of heat via the bottom may, however, also take place by heat radiation, e.g. by irradiating the tank bottom with electromagnetic waves, in particular infrared light.

It is known that lithography-based generative manufacturing involves significant shrinking of the exposed layer during the chemical reaction. Such shrinking will subsequently cause internal stresses and warping of the final component. The extent of shrinking depends on the concentration of reactive groups. The higher the concentration of reactive groups (e.g. acrylate groups, methacrylate groups or epoxide groups) the higher the shrinkage. When using longer-chain starting monomers, the photopolymer will have a lower density of reactive groups. These longer-chain starting monomers increase the viscosity as compared to thin photopolymers known from the literature. By the present method for processing highly viscous photopolymers, it has thus become possible to minimize the shrinkage of the component and hence achieve an enhanced precision of the component.

Due to the elevated temperature prevailing in the process zone, the reactivity of the photopolymer will also be increased. As compared to processing at room temperature, a reduction of reactive groups has thus become possible without deteriorating the reactivity of the overall system.

In the context of the invention, a photopolymerizable material having a relative molecular weight of at least 5000 is preferably used. In a preferred manner, the following photopolymer/monomer systems can be used:
mono- and multifunctional urethane acrylates and urethane methacrylates having a relative molecular weight of at least 5000;
mono- and multifunctional acrylates and methacrylates with aromatic spacers having a relative molecular weight of at least 5000;
mono- and multifunctional epoxides having a relative molecular weight of at least 5000.

A particular advantage of the present invention resides in the exploitation of the fact that during the position-selective exposure of the respective material layers surrounding material will remain adhered to the free surfaces of the cured layer. With conventional, rather thin photopolymers, such adhering material will run down the surfaces of the shaped body in the course of the continued layer construction, thus returning into the liquid material bath. On the other hand, with highly viscous starting materials, the uncured material, which cools to room temperature as it emerges from the material bath, will reassume its near-solid consistency so as to remain adhered to the surface of the shaped body if a lower temperature than in the process zone prevails in the remaining construction space. The adhering material, which is, in particular, comprised of solidified residual monomer, can subsequently serve as a support material for the forming shaped body in a particularly advantageous manner. The support material can thus substitute for an otherwise required, separate support, which has to be mechanically connected to the shaped body in conventional methods (e.g. stereolithography) according to the prior art. In the present method, the solidified support material can be removed again in a simple manner by slightly heating the shaped body subsequent to the construction process. A process in which the mechanical removal of support structures is no longer necessary has thus become available, which is highly advantageous for the automation of the manufacture of 3D-printed components. Alternatively, the support body can be constructed in layers of cured material together with the shaped body, wherein only at least one layer at the transition between the support body and the part of the shaped body to be subsequently supported is formed of uncured material that is allowed to solidify by cooling. The thus produced adhesive layer between the support body and the part of the shaped body to be supported can subsequently be made soft and fluid by heating the finished shaped body so as to enable easy removal of the support body.

The method according to the invention in this context is further developed such that uncured photopolymerizable material adhering to the part of the shaped body formed on the construction platform is allowed to solidify by cooling. Cooling may in this case take place in stagnant ambient air. Yet, uncooled ambient air in motion can also be used to accelerate cooling to room temperature. Alternatively, the use of various cooling units operating with coolants cooled to below ambient temperature is, of course, possible.

To promote the formation of two temperature zones, a thermal insulation can be arranged between the bath of the photo-polymerizable material and the construction platform, or the shaped body formed thereon. The undesired input of heat from the heated bath into the cooling zone disposed thereabove will thus be minimized.

Advantageous material properties will preferably also be achieved in that the photopolymerizable material is filled with sinterable material such as ceramic material or metal, as mentioned in the beginning. In this case, it has turned out that high-quality components will, in particular, be produced at a degree of filling between 42 and 65% by volume.

Methods of the type disclosed herein mostly use tools for circulating or redistributing the material in the tank so as to ensure a homogenous material layer. The invention in this respect is preferably further developed to the effect that the photopolymerizable material, prior to step b), is distributed in the tank with the aid of a doctor knife moved through below the construction platform so as to achieve a uniform layer thickness, wherein the doctor knife preferably comprises two doctor blades spaced-apart in the direction of movement and moved over the tank bottom at a constant distance thereto. In a configuration comprising two blades, the doctor knife will, in particular, also ensure constant and rapid supplies of unused slip. In this respect, it is preferably provided that the vertical distance of the doctor blades relative to the tank bottom is adjusted by the aid of a simple adjustment unit, thus allowing the adjustment of the layer thickness of the material applied. The doctor knife is preferably connected to a drive unit driving it to a reciprocating movement. The configuration comprising two doctor blades enables material charging in both directions of movement so as to considerably reduce the process time. By contrast, in systems using conventional doctor knifes, the doctor knife or wiper element has to be moved forward and backward before a new layer can be applied.

The configuration comprising two doctor blades, furthermore, has the advantage that a chamber can be formed between the doctor blades, which chamber may serve as a reservoir for unused material. During the reciprocating movement of the doctor knife in the distribution step, unused material is thus able to flow downwards out of the chamber to fill possibly existing holes, open spaces or depressions in the material layer, the doctor knife lagging in the direction of movement defining the layer thickness. Holes, open spaces or depressions in the bath level will, in particular, result in the region in which the construction platform or the already cured layers of the shaped body are withdrawn from the bath after the exposure procedure. Since the unused slip is primarily contained in the chamber, relatively little material is required for starting the construction process and maintaining reliable material supplies.

During the reciprocating movement of the doctor knife, the doctor blade running ahead in the direction of movement pushes ahead excess material until the doctor knife has arrived at the other end of the tank. There, the excess material, which has collected in the form of a small wave in front of the blade, accumulates between the doctor blade and the end wall of the tank, and tends to flow back laterally beside the doctor knife or over the upper edge of the doctor knife. In order to utilize or process the accumulating material, it is preferably provided that the material is pressed into a chamber formed between the two doctor blades through overflow channels during or at the end of the distribution step. This will cause the material in the chamber to be available again for the subsequent distribution step. Besides, the material will be constantly blended by being squeezed and flowing through the overflow channels such that the risk of demixing, in particular of filled photopolymers, will be considerably reduced.

During the method according to the invention, sufficient supplies of fresh photopolymer have to be ensured, if necessary.

In a particularly simple manner, it is provided in this context that fresh photopolymerizable material is refilled by being introduced into an upwardly open chamber formed between the two doctor blades. Refilling is accomplished via the upper opening of the chamber, preferably by using a dosing unit.

A preferred further development, moreover, provides that at least a third doctor blade is provided, which is preferably disposed between the two doctor blades and moved in such a position that unused material is lifted from the tank bottom. In this manner, the unused material is lifted from the tank bottom at every reciprocating movement of the doctor knife and transported into the chamber formed between the two doctor blades, where thorough mixing and homogenization will occur.

In order to ensure that the third doctor blade need not be separately readjusted when adjusting the height of the doctor knife, the third doctor blade is preferably disposed so as to be resiliently pressable against the tank bottom. This can be realized in that the blade itself is made of elastic material, or in that the blade is held to be inwardly displaceable against a restoring force. This will cause the third doctor blade to contact the tank bottom independently of the respective height position of the doctor knife.

To solve the object underlying the invention, the invention according to a further aspect provides a device for processing photopolymerizable material for the layered construction of a shaped body, comprising
a tank having a bottom transparent at least in some region, into which photopolymerizable material can be filled;
a construction platform, which is held at an adjustable height above the tank bottom;
an exposure unit capable of being controlled from below through the tank bottom for the position-selective exposure of a material layer formed between the lower side of the construction platform and the tank bottom;
a control unit arranged to polymerize in successive exposure steps superimposed layers on the construction platform each with a specified geometry by controlling the exposure device, and to adapt the relative position of the construction platform relative to the tank bottom after each exposure step for a layer so as to successively construct the shaped body in the desired shape.

In accordance with the invention, said device is characterized by a stationary heating device for heating the total amount of the photopolymerizable material in the tank to a temperature of at least 30° C. In doing so, it is essential that the heating device constitutes a device separate from the exposure unit.

The heating device preferably comprises at least one heating element disposed on or in the tank bottom, e.g. a heating film. A heating film comprises a thin carrier element, e.g. of plastic, in which mostly meander-like heating wires configured as resistance heating are disposed. The heating device, e.g. heating film, can be arranged outside the transparent bottom region of the tank. In particular, two heating elements, e.g. heating films, can be provided, one element being each arranged on both sides of the transparent bottom region or exposure area. In these lateral regions, the parking position of the doctor knife is provided during the exposure procedure. Such an arrangement thus allows for not only a failure-free exposure but also rapid heating of the unused photopolymer, which, in the event of a doctor knife comprising two blades, will primarily be present in the chamber between the two doctor blades.

Alternatively, or additionally, it may be provided that the heating device extends at least partially over the transparent bottom region of the tank and is designed to be transparent. In this case, the optical properties of the heating film have, however, to be borne in mind, in particular the transparency and the fact that no coarse particles be included.

Temperature control will be particularly easy if a temperature sensor is provided, which interacts with the control unit for controlling the heating power of the heating device in such a manner as to allow a specified temperature of the photopolymerizable material to be attained and/or maintained. The temperature sensor is preferably designed as a PT temperature probe and can be incorporated in the heating film.

In order to promote the formation of a support structure comprised of unused photopolymer for the forming shaped body, it is preferably provided that the construction platform is associated with a cooling device for cooling, and allowing to solidify, uncured photopolymerizable material adhering to the part of the shaped body formed on the construction platform.

In a preferred manner, a movably guided doctor knife and a drive unit for the reciprocating movement of the doctor knife through below the construction platform are provided, said doctor knife preferably comprising two doctor blades spaced apart in the direction of movement and movable over the tank bottom at a constant distance thereto. In this respect, a preferably downwardly open chamber may advantageously be formed between the two preferably parallel doctor blades, at least one wall of which chamber comprises at least one opening passing through said wall in the moving direction of the doctor knife for forming an overflow channel.

In order to prevent photopolymerizable material in the region of the doctor knife, in particular the material present in the reservoir chamber between the two doctor blades, from cooling, a preferred further development provides that the doctor knife is heatable. The doctor knife can, in particular, be equipped with at least one heating element, for instance an electric resistance heating element.

A further preferred development contemplates that at least one opening is each formed in two oppositely located walls of the chamber.

Furthermore, the downwardly open chamber, on the end sides between the two doctor blades, may each comprise an inlet opening so as to enable also material accumulating, near the bottom, on the doctor blade running ahead in the direction of movement to flow into the chamber.

In addition, at least a third doctor blade can be provided, which is preferably disposed between the two doctor blades and projects relative to the two doctor blades in the direction towards the tank bottom.

In a particularly preferred manner, the doctor knife plus the two outer doctor blades is formed in one piece. The doctor blade in this case is preferably made of a polymer material, e.g. polytetrafluoroethylene or polyoxymethylene. The doctor knife can thus be configured to be particularly wear-resistant and rigid. Due to the high wear resistance, no major abrasion will occur during operation such that the photopolymer will not be contaminated. The materials proposed for the doctor knife are, moreover, easy to clean.

The exposure unit can basically be configured in any manner whatsoever, the invention being not limited to the use of visible light. In fact, any electromagnetic radiation is suitable, by which the photopolymerizable material used can be cured. Thus, UV light may, for instance, be applied. Alternatively, light having a wavelength in the visible range can be used.

The exposure unit is preferably disposed below the tank bottom. It is controlled by the control unit to selectively expose a specified exposure area on the lower side of the tank bottom with a pattern in the desired geometry. The exposure unit preferably comprises a light source including one or more light-emitting diodes, whereby a luminous power of about 15 to 200 mW/cm2 is preferably achieved in the exposure area. The wavelength of the light irradiated by the exposure unit preferably ranges between 350 and 500 nm. The light of the light source can be modulated in terms of intensity by position-selective exposure via a light modulator and projected to the exposure area on the lower side of the tank bottom in the resulting intensity pattern with the desired geometry. As light modulators, various types of DLP chips (digital light processing chips) such as micromirror fields, LCD fields and the like may be envisaged. Alternatively, the light source may comprise a laser whose light beam will successively scan the exposure area via a movable mirror controlled by the control unit.

The construction platform is preferably held above the tank bottom in a lifting mechanism so as to be adjustable in height by the control unit. The control unit is preferably arranged to adjust the thickness of the layer, i.e. the distance between the construction platform, or the last layer produced, and the tank bottom via the lifting mechanism.

The tank is preferably formed in two parts, comprising a, preferably multilayer, transparent tank bottom and a material tank frame. The lowermost layer of the tank bottom is, for instance, comprised of a massive glass panel that serves as a supporting element. It is superimposed by a silicone layer and a nonstick film, which ensure a reduction of the reaction forces during the printing process. The frame is preferably made of a chemically resistant plastic material.

In addition to functioning as a material container, the tank frame, at the same time, advantageously also serves as a bracing means for the tank system. A simple and rapid tank exchange is thus enabled. The two-part design of the tank system allows for uncomplicated and rapid cleaning after the printing process.

Moreover, a single tank body may be subdivided into several tank segments mutually separated by partition walls so as to form a plurality of tanks in the sense of the invention.

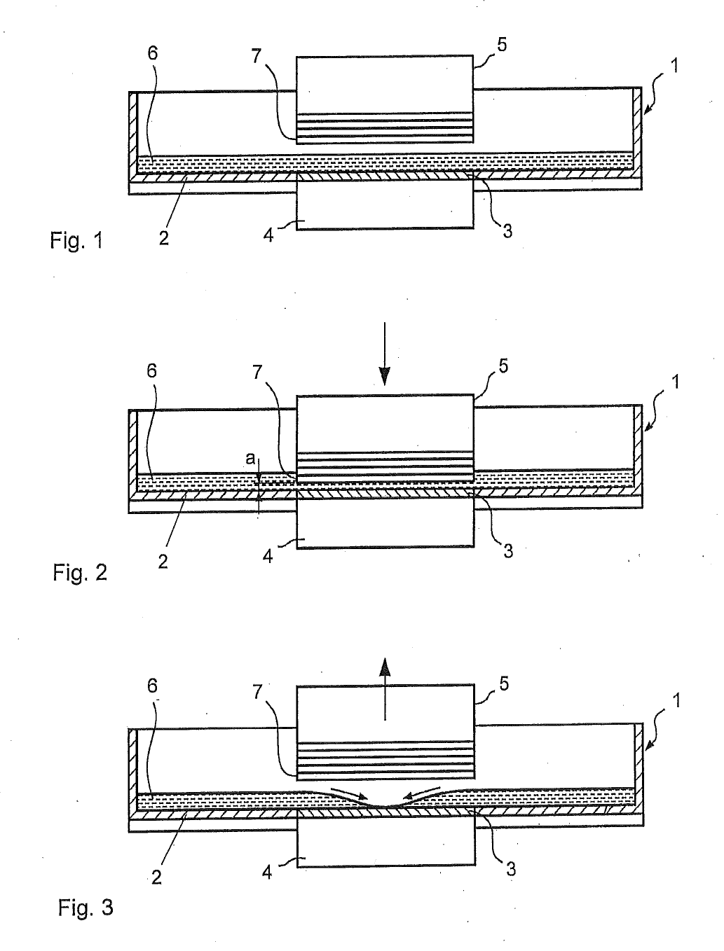

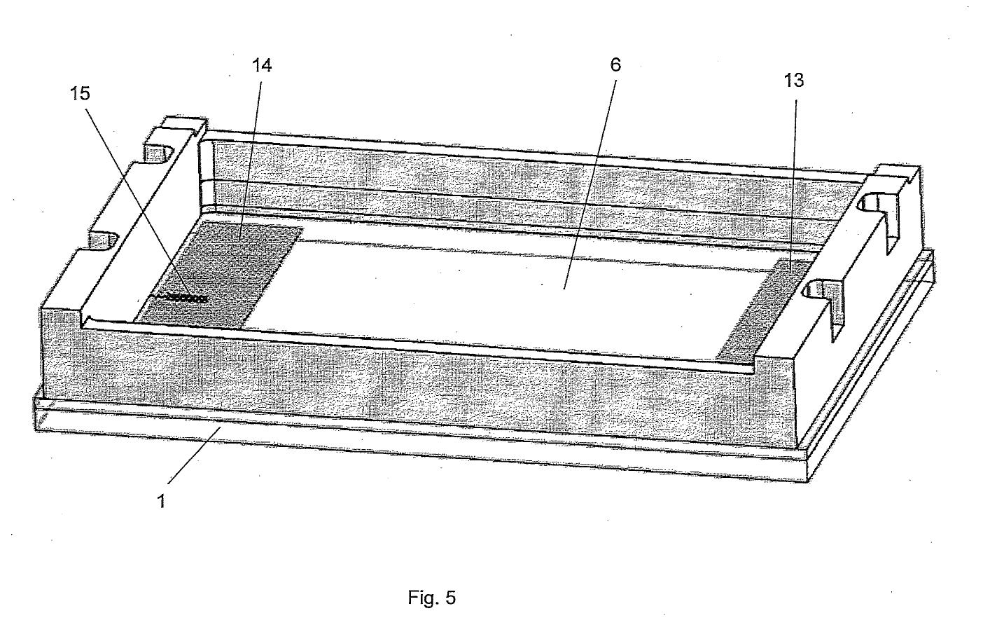

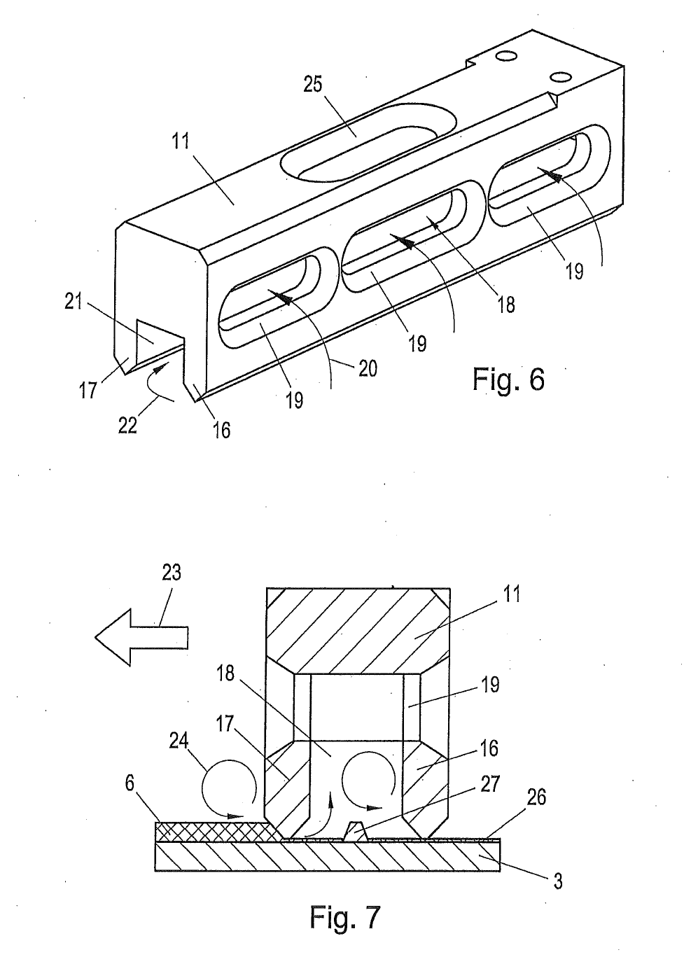

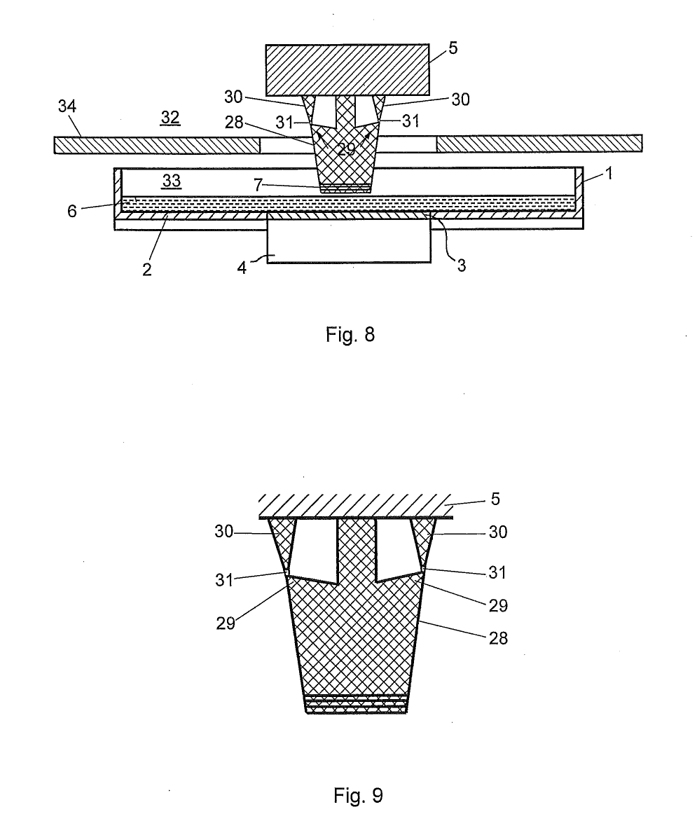

In the following, the invention will be explained in more detail by way of exemplary embodiments schematically illustrated in the drawing. Therein, FIGS. 1 to 3 are schematic, lateral sectional views of a device according to the invention in successive phases of the method; FIG. 4 is a perspective view of the device without construction platform; FIG. 5 is a perspective view of the tank according to FIG. 4; FIG. 6 is a perspective view of the doctor knife used according to the invention; FIG. 7 is a schematic sectional view of the doctor knife according to FIG. 6; FIG. 8 depicts a modified configuration of the device according to the invention, comprising two temperature zones; and FIG. 9 is an enlarged illustration of the shaped body of FIG. 8.

The operating principle of a device according to the invention will, at first, be described with reference to FIGS. 1 to 3, wherein reference is also made to the device disclosed in EP 2505341 A1. The device comprises a tank 1 whose tank bottom 2 is transparent or translucent at least in a partial region 3. This partial region 3 of the tank bottom 2 at least covers the extension of an exposure unit 4 disposed below the tank bottom 2. The exposure unit 4 comprises a light source and a light modulator for adjusting in a position-selective exposure the intensity controlled by a control unit, in order to generate an exposure field on the tank bottom 2 with the geometry desired for the layer to be currently formed. Alternatively, the exposure unit 4 may also use a laser whose light beam successively scans the exposure field with the desired intensity pattern via a movable mirror controlled by a control unit.

Opposite the exposure unit 4 and above the tank 1 is provided a construction platform 5, which is supported by a lifting mechanism (not illustrated) so as to be held in a height-adjustable manner above the tank bottom 2, above the region of the exposure unit 4. The construction platform 5 can likewise be transparent or translucent such that light can be radiated in by a further exposure unit provided above the construction platform 5 in order to expose also from above at least the first layer during its formation on the lower side of the construction platform 5 so as to ensure that the first layer cured on the construction platform 5 will indeed reliably adhere to the latter.

The tank 1 contains a fill of highly viscous photopolymerizable material 6. The meniscus of the fill is clearly higher than the thickness of the layers that are to be defined for the position-selective exposure. The definition of a layer of photopolymerizable material is performed in the following manner. The construction platform 5 is lowered by the lifting mechanism in a controlled manner such that (prior to the first exposure step) its lower side is immersed in the fill of photopolymerizable material 6 and approaches the tank bottom 2 to such an extent that exactly the desired layer thickness a (cf. FIG. 2) will remain between the lower side of the construction platform 5 and the tank bottom 2. During this immersion process, photopolymerizable material is forced out of the interspace between the lower side of the construction platform 5 and the tank bottom 2. After having adjusted the layer thickness a, the position-selective exposure of the layer desired for said layer will occur in order to allow the same to cure in the desired shape. In particular during the formation of the first layer, exposure may also be effected from above through the transparent or translucent construction platform 5 in order to ensure safe and complete curing, in particular in the contact region between the lower side of the construction platform 5 and the photopolymerizable material 6, and hence a good adherence of the first layer to the construction platform 5. After the formation of the layer, the construction platform 5 is again lifted by the lifting mechanism.

These steps are subsequently repeated several times, the distance of the lower side of the last-formed layer 7 relative to the tank bottom 2 being each adjusted to the desired layer thickness a and the next layer being subsequently cured in a position-selective manner as desired.

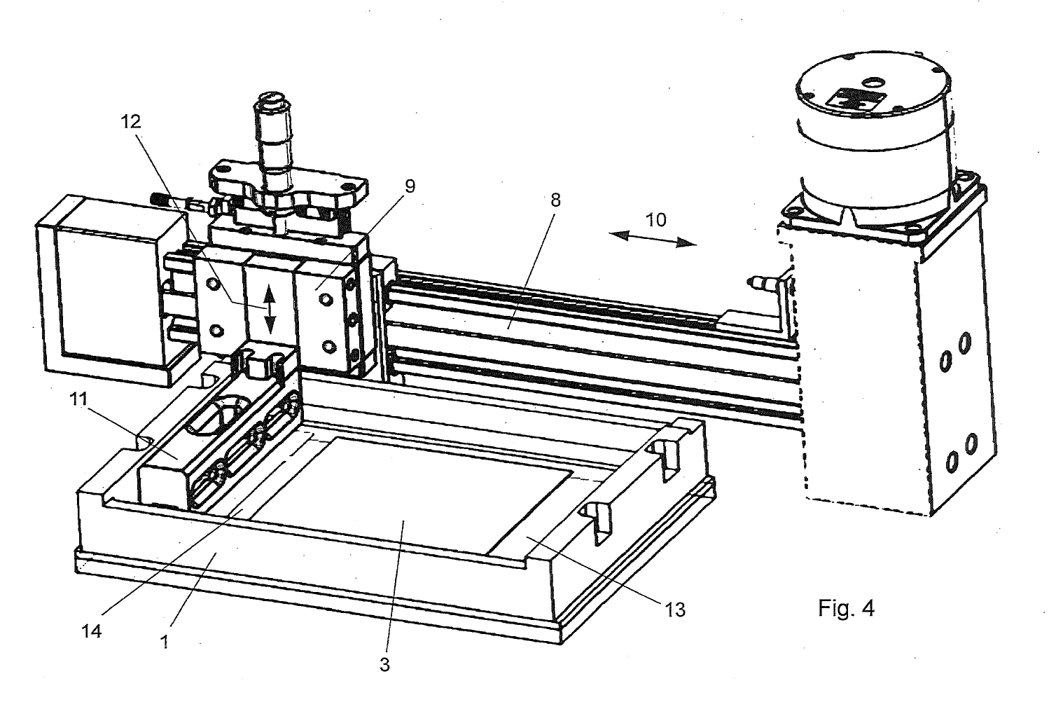

After having lifted the construction platform 5 after an exposure step, a material deficit will be present in the exposed area as indicated in FIG. 3. This is due to the fact that, following the curing of the adjusted layer with the thickness a, the material from this layer is cured and lifted along with the construction platform 5 and the part of the shaped body already formed thereon. The photopolymerizable material thus missing between the lower side of the already formed part of the shaped body and the tank bottom 2 has to be filled up with the fill of photopolymerizable material 6 from the surrounding region of the exposed area. Due to the high viscosity of the material, the latter does, however, not automatically flow back into the exposed area between the lower side of the shaped body part and the tank bottom such that material sinks or “holes” may be left there.

The illustration according to FIG. 4 depicts the components of the device omitted in FIGS. 1 to 3 for the sake of clarity. The tank is again denoted by 1, its bottom having a transparent region 3. A guide rail 8 on which a carriage 9 is movably guided in the sense of double arrow 10 is associated to the tank 1. A drive serves to reciprocate the carriage 9, which comprises a bracket for a doctor knife 11. The bracket includes a guide and an adjustment device for vertically adjusting the doctor knife 11 in the sense of double arrow 12. Thus, the distance of the lower edge of the doctor knife 11 from the bottom of the tank 1 can be adjusted. The doctor knife 11 is employed after the construction platform has been lifted as illustrated in FIG. 3, and serves to uniformly distribute the material 6 upon adjustment of a specified layer thickness in order to compensate for the material deficit occurring in the region of the construction platform 5, and feed new material, if required. The layer thickness of the material 6 resulting from the material distribution procedure is defined by the distance of the lower edge of the doctor knife 11 from the bottom 2 of the tank 1.

Furthermore, heating films 13 and 14 provided on both sides of the transparent region 6 of the tank bottom 2 are apparent from FIG. 4, said heating films 13, 14 serving to heat the material 6 in order to reduce its viscosity.

From FIG. 5, the heating films 13 and 14 are more clearly apparent. In addition, a temperature sensor 15 is shown, which serves to measure the temperature of the heating film 14 and the material 6, respectively.

FIG. 6 illustrates in detail the configuration of the doctor knife 11. The doctor knife comprises two parallel doctor blades 16 and 17 between which a chamber 18 is formed in the interior of the doctor knife 11. On the longitudinal side of the doctor knife 11 are provided three overflow channels 19, via which material 6 can flow into the chamber 18 along arrows 20. Respective overflow channels are also provided on the rear longitudinal side of the doctor knife 11, yet are not visible in FIG. 6. Moreover, the chamber 18 is open on the end sides of the doctor knife 11 (openings 21) so as to enable the inflow of material 6 along arrow 22 also there. If required, new material can be introduced into the chamber 18 via the upper opening 25.

In the following, the functioning of the doctor knife 11 will be explained by way of the sectional view according to FIG. 7. At a movement of the doctor knife 11 in the sense of arrow 23, the lower edges of the doctor blades 16 and 17, respectively, define a material layer 26 with a specified layer thickness. The doctor blades 16 and 17 are disposed at equal distances from the bottom 3. Excess material 6 is moved in front of the doctor blade 17 running ahead in the moving direction, with a flow movement in the sense of arrow 24 resulting. As the doctor knife 11 is moved against the inner wall of the tank 1 at the end of its movement, the material accumulated in front of the doctor blade 17 is pressed into the chamber 18 via the overflow openings 19. Laterally, the material can flow into the chamber 18 via the lateral openings 21.

Between the doctor blades 16 and 17, a third doctor blade 27 is provided, which is schematically indicated in FIG. 7 and arranged more deeply than the doctor blades 16 and 17. The third doctor blade 27 touches the tank bottom 3, lifting unused material from the tank bottom. At every reciprocating movement of the doctor knife 11, unused material will thus be transported into the chamber 18, where blending and homogenization will occur.

In that the doctor knife 11 comprises two doctor blades 16 and 17 as well as a chamber 18 and is designed to be substantially symmetrical, a backward or a forward movement will do to uniformly distribute the material for the subsequent exposure step. This is an essential advantage over conventional configurations, in which both a backward and a forward movement are required for this purpose.

FIG. 8 depicts a device according to FIGS. 1 to 3, in which two temperature zones are provided in addition. The same reference numerals as in FIGS. 1-3 are used for identical parts. The device comprises a tank 1 whose tank bottom 2 is transparent or translucent in at least a partial region 3. This partial region 3 of the tank bottom 2 at least covers the extension of an exposure unit 4 disposed below the tank bottom 2. Opposite the exposure unit 4 and above the tank 1 is provided a construction platform 5, which is supported by a lifting mechanism (not illustrated) so as to be held in a height-adjustable manner above the tank bottom 2 in the region of the exposure unit 4. A fill of highly viscous photopolymerizable material 6 is contained in the tank 1. In the manner described in connection with FIGS. 1 to 3, a plurality of layers 7 is built up, of which only the lowermost layers are entered for the sake of clarity. In the exemplary embodiment according to FIG. 8, a shaped body 28 comprising two overhanging portions 29 was constructed.

During the construction process, a support body 30 has to be provided for each of the overhanging portions 29. In this case, the support bodies 30 assume the function of a construction platform for the overhanging portions 29. The support bodies 30 can be premounted on the construction platform 5 or—as in the present exemplary embodiment—built up in layers together with the shaped body 28. On the transition between the support bodies 30 and the overhanging portions 29 to be constructed, at least one schematically indicated layer 31 of non-polymerized material is formed. The layer 31 forms in that material from the bath 6 remains adhered to the support bodies, which material will function as an adhesive layer between the support bodies 30 and the respectively overhanging portion 29 after curing. In order to promote the curing of the material, a cooling zone 32 is provided, in which a lower temperature than in the zone 33 of the heated bath 6, in particular ambient temperature or a temperature <20° C., prevails. In order to ensure the thermal separation of the two zones 32 and 33, a thermal insulation 34 is arranged between said zones. The thermal insulation 34 is preferably plate-shaped, in particular annular, and placed directly above the tank 1.

The work that led to this invention was supported by the European Union within the Seventh Framework Programme under the Grant Agreement No. 26043 (PHOCAM).

1-23. (canceled)

24. A method for processing photopolymerizable material for the layered construction of a shaped body, comprising
a) providing a tank having a bottom transparent at least in some region thereof, in which the photopolymerizable material is contained, wherein the photopolymerizable material has a viscosity of at least 20 Pa·s at room temperature (20° C.), and the photopolymerizable material forming a layer in the tank;
b) moving a construction platform to such a height that a layer of the photopolymerizable material with a specified thickness is defined between the lower side of the construction platform or, if already present, the lowermost cured layer of the part of the shaped body formed thereon and the tank bottom;
c) exposing the layer from below through the tank bottom by position-specific exposure to light so as to cure the material layer in the desired shape; and
d) repeating steps b) and c) until the last layer of the shaped body is formed,
wherein before b) the method includes heating the layer of the photopolymerizable material (6) in the tank to a temperature of at least 30° C. so as to lower its viscosity, characterized in that heating of the layer of the photopolymerizable material (6), and optionally maintaining of the temperature, is effected by the input of heat over a large area and directly on the tank bottom (2) and only in a process zone, in particular by at least one heating element disposed on or in the tank bottom (2), e.g. heating films, the process zone comprising the region between the transparent tank bottom (2) and the shaped body being constructed.

25. A method according to claim 24, characterized in that the temperature of the photopolymerizable material (6) is maintained at a temperature of at least 30° C. during steps b), c), and d).

26. A method according to claim 24, characterized in that the photopolymerizable material (6) has a molecular weight of at least 5000.

27. A method according to claim 24, characterized in that uncured photopolymerizable material (6) adhering to the part of the shaped body formed on the construction platform (5) is allowed to solidify by cooling.

28. A method according to claim 24, characterized in that the photopolymerizable material (6) further comprises filler particles.

29. A method according to claim 24, characterized in that the photopolymerizable material (6), prior to step b), is distributed in the tank with the aid of a doctor knife (11) moved through below the construction platform (5) so as to achieve a uniform layer thickness, wherein the doctor knife (11) comprises at least two doctor blades (16, 17) spaced-apart in the direction of movement and moved over the tank bottom (2) at a constant distance thereto.

30. A method according to claim 29, characterized in that the photopolymerizable material (6) is pressed into a chamber (18) formed between the two doctor blades (16, 17) through overflow channels (19) during the distribution step.

31. A method according to claim 29, characterized in that the method further comprises introducing fresh photopolymerizable material (6) to refill, in whole or in part, the tank through an upwardly open chamber (18) formed between the two doctor blades (16, 17).

32. A method according to claim 29, characterized in that at least a third doctor blade (27) is provided, disposed between the at least two doctor blades (16, 17) and moved in such a position that unused material is lifted from the tank bottom (2).

33. A method according to claim 24, characterized in that a thermal insulation is arranged between the bath of the photopolymerizable material (6) and the construction platform (5), or the shaped body formed thereon, so as to provide two temperature zones.

34. The method according to claim 24, characterized in that in the method, the heating directly over a large surface area of the tank bottom is provided by at least one heating element disposed on or in the tank bottom (2), the heating element comprising heating films; and the photopolymerizable material (6) further comprising, as filler particles, particles of ceramic or a metal.

35. A device for carrying out the method according to claim 24, comprising
a tank having a bottom transparent at least in some region, into which photopolymerizable material can be filled;
a construction platform, which is held at an adjustable height above the tank bottom;
an exposure unit capable of being controlled from below through the tank bottom for the position-selective exposure of a material layer formed between the lower side of the construction platform and the tank bottom;
a control unit arranged to polymerize in successive exposure steps superimposed layers on the construction platform each with a specified geometry by controlling the exposure device, and to adapt the relative position of the construction platform relative to the tank bottom after each exposure step for a layer so as to successively construct the shaped body in the desired shape; and
a stationary heating device for heating a layer of the photopolymerizable material in the tank to a temperature of at least 30° C.,
characterized in that the heating device comprises at least one heating element disposed on or in the tank bottom (2) and that is configured such that the input of heat occurs over a large area and directly on the tank bottom (2) and only in a process zone of the plant, the process zone comprising the region between the transparent tank bottom (2) and the shaped body being constructed.

36. A device according to claim 35, characterized in that the heating device is disposed outside the transparent bottom region of the tank (1).

37. A device according to claim 35, characterized in that the heating device extends at least partially over the transparent bottom region of the tank (1) and is designed to be transparent.

38. A device according to claim 35, characterized in that a temperature sensor (15) is provided, which interacts with the control unit for controlling the heating power of the heating device in such a manner as to allow a specified temperature of the photopolymerizable material (6) to be attained and/or maintained.

39. A device according to claim 35, characterized in that the construction platform (5) is associated with a cooling device for cooling, and allowing to solidify, uncured photopolymerizable material (6) adhering to the part of the shaped body formed on the construction platform (5).

40. A device according to claim 35, characterized in that a movably guided doctor knife (11) and a drive unit for the reciprocating movement of the doctor knife (11) through below the construction platform (5) are provided, said doctor knife (11) preferably comprising two doctor blades (16, 17) spaced apart in the direction of movement and movable over the tank bottom (2) at a constant distance thereto.

41. A device according to claim 40, characterized in that a preferably downwardly open chamber (18) is formed between the two preferably parallel doctor blades (16, 17), at least one wall of which chamber comprises at least one opening (19) passing through said wall in the moving direction of the doctor knife (11) for forming an overflow channel.

42. A device according to claim 41, characterized in that at least one opening (21) is each formed in two oppositely located walls of the chamber (18).

43. A device according to claim 41, characterized in that the downwardly open chamber (18), on the end sides between the two doctor blades (16, 17), each comprises an inlet opening.

44. A device according to claim 41, characterized in that the chamber (18) comprises a refill opening on its upper side.

45. A device according to claim 40, characterized in that the doctor knife (11) plus doctor blades (16, 17) is formed in one piece and preferably made of a polymer material, e.g. polytetrafluoroethylene or polyoxymethylene.

46. A device according to claim 35, characterized in that a thermal insulation is arranged between the bath of the photopolymerizable material (6) and the construction platform (5), or the shaped body formed thereon, so as to provide two temperature zones.
